(19) United States
(12) Patent Application Publication
(10) Pub. No.: US 2026/0356750 A1
(43) Pub. Date: Nov. 12, 2026

(54) Fiber Enhanced Joint Compound Composition

(71) Applicant: ProForm Finishing Products, LLC, Charlotte, NC (US)

(72) Inventors: Charles Miner, Fort Worth, TX (US); Edwin Escobar, Acworth, GA (US); Paul Palyukh, Windermere, FL (US)

(21) Appl. No.: 19/125,017

(22) PCT Filed: Oct. 25, 2023
(86) PCT No.: PCT/US2023/035885

§ 371 Date: Apr. 28, 2025

Related U.S. Application Data
(60) Provisional application No. 63/420,155, filed on Oct. 28, 2022.

(51) Int. Cl. C04B 16/06; C04B 14/10; C04B 14/28; C04B 26/04; C04B 103/40; C04B 103/50; C04B 103/69; C04B 111/00

(52) U.S. Cl. CPC C04B 16/06; C04B 14/102; C04B 14/28; C04B 26/04; C04B 2103/402; C04B 2103/406; C04B 2103/50; C04B 2103/69; C04B 2111/00681

(57) ABSTRACT

In the present disclosure, a joint compound composition is disclosed. The joint compound composition comprises water, a cementitious filler, and fiber. The joint compound composition of the present disclosure possesses enhanced strength and enhanced crack resistance. The present disclosure is also directed to a method of making a joint compound composition. The method comprises combining and mixing water, a cementitious filler, and fiber.

### RELATED APPLICATIONS

The present application is based on and claims priority to U.S. Provisional Patent Application Ser. No. 63/420,155, having a filing date of Oct. 28, 2022, which is incorporated herein by reference in its entirety.

### BACKGROUND

Joint compound compositions are commonly used in the building industry in combination with gypsum wallboards. For instance, gypsum wallboards are affixed to a support structure, typically using screws or nails. When multiple gypsum wallboards are affixed, the gaps between adjacent gypsum wallboards are typically referred to as joints. In order to achieve a smooth, visually appealing surface, the joints between the gypsum wallboards, any cracks, screw holes, and/or nail holes should be concealed. Typically, joint compound compositions are utilized for such purposes. In particular, one such type of joint compound composition is a drying-type joint compound. Typically for these joint compound compositions, the composition is mixed for a specific time with water prior to use and is then applied. After application, the water evaporates and the compound dries to form a relatively hard cementitious material. While many types of drying-type joint compound compositions exist, they may still exhibit some deficiencies. For instance, the joint compound composition may have deficient strength and may be vulnerable to crack formation over time. Further, for instance, the joint compound composition may comprise additives that may be harmful to the environment and/or people.

As a result, there is a need to provide an improved joint compound composition, in particular a joint compound composition with enhanced strength and crack resistance.

### SUMMARY OF THE INVENTION

In accordance with one embodiment of the present invention, a joint compound composition is disclosed. The joint compound composition comprises water, a cementitious filler, and natural fiber, wherein the natural fiber is present in the joint compound composition in an amount from about 0.05 wt. % to about 20 wt. %, wherein the joint compound composition has a viscosity from about 100 BU to about 1000 BU.

In accordance with another embodiment of the present invention, a method of making a joint compound composition is disclosed. The method comprises: combining water, a cementitious filler, and the natural fiber, wherein the natural fiber is present in the joint compound composition in an amount from about 0.05 wt. % to about 20 wt. %, wherein the joint compound composition has a viscosity from about 100 BU to about 1000 BU, applying the joint compound composition to a joint between adjacent gypsum wallboards, allowing the joint compound composition to dry and cure, and applying a tape to a portion of the joint compound composition or to the entirety of the joint compound composition.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a joint compound composition. The joint compound composition may include water, a cementitious filler, and fiber. The present inventors have discovered that the particular joint compound composition as disclosed herein provides various advantages, in particular when utilized within the building industry. For instance, the joint compound composition may have enhanced flexural strength, improved drying time, enhanced tensile strength, enhanced compressive strength, and increased resistance to crack formation (i.e., crack resistance).

In addition to the advantages disclosed above, the joint compound composition as disclosed herein may also exhibit other beneficial properties. For instance, the joint compound composition may also result in one or more of reduced cratering, reduced shrinking, greater sag resistance, and excellent workability.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

In one aspect, the joint compound composition may include fiber. For instance, the joint compound composition may include a natural fiber. In one aspect, the natural fiber may include cork fiber, hemp fiber, cotton fiber, kenaf fiber, jute fiber, sisal fiber, ramie fiber, roselle fiber, flax fiber, sunn fiber, coir fiber, pina fiber, milkweed fiber, linen fiber, urena fiber, or a combination thereof.

In one aspect, the natural fiber may include cellulose fiber. The cellulose fiber may be derived from wood fiber, cork fiber, hemp fiber, cotton fiber, kenaf fiber, jute fiber, sisal fiber, ramie fiber, roselle fiber, flax fiber, sunn fiber, coir fiber, pina fiber, milkweed fiber, linen fiber, urena fiber, or a combination thereof.

It should be understood that the joint compound composition of the present disclosure may include one or more of the aforementioned fibers in any combination thereof. For instance, the joint compound composition may include natural fiber, the natural fiber comprising more than one type of natural fiber.

Notably, the joint compound composition may include a natural fiber which may include cellulose fiber, such as microcellulose fiber and/or nanocellulose fiber. The cellulose fiber may be particularly suitable for use in a joint compound composition. For instance, the cellulose fiber may enhance the tensile strength, enhance the compressive strength, and increase the crack resistance of the joint compound composition.

The cellulose fiber may be physically and/or chemically modified. In one aspect, the cellulose fiber may be physically modified by a mechanical treatment, a heat treatment, a UV modification treatment, a gamma irradiation treatment, a corona modification treatment, a plasma treatment, or a combination thereof. For instance, a mechanical treatment may include refining the cellulose fiber. In this respect, the fibers may be subjected to mechanical compression and shearing. The refining of the cellulose fiber may enhance the flexibility of the cellulose fiber and may enhance the bond strength between the cellulose fiber and the joint compound composition matrix. In this respect, the refining of the cellulose fiber may enhance the strength and crack resistance of the joint compound composition. The cellulose fiber may have a Schopper-Riegler degree of refining from about 0° SR to about 90° SR, including all increments of 1° SR therebetween, such as about 0° SR or more, such as about 10° SR or more, such as about 20° SR or more, such as about 30° SR or more, such as about 40° SR or more, such as about 50° SR or more, such as about 60° SR or more, such as about 70° SR or more, such as about 80° SR or more, such as about 90° SR or less, such as about 80° SR or less, such as about 70° SR or less, such as about 60° SR or less, such as about 50° SR or less, such as about 40° SR or less, such as about 30° SR or less, such as about 20° SR or less.

In one aspect, the cellulose fibers may be chemically modified. For instance, the cellulose fibers may be chemically modified by oxidation, carboxymethylation, succinylation, sulfonation, phosphorylation, esterification, polymer grafting, or a combination thereof.

Generally, the fiber (e.g., cellulose fiber) may have a selectively chosen average fiber diameter. In one aspect, an increase in the average fiber diameter of the fiber may increase the strength and crack resistance of the joint compound composition. Notably, too much of an increase in the average fiber diameter of the fiber may result in a decreased number of fibers per unit volume in the joint compound composition, which may negatively affect the strength and crack resistance of the joint compound composition. In this respect, the average fiber diameter of the fiber may be selectively chosen to increase the strength and crack resistance of the joint compound composition while also maintaining a suitable number of fibers per unit volume in the joint compound composition.

In one aspect, the fiber (e.g., cellulose fiber) may have an average fiber diameter of about 1 nanometer to about 100 microns, including all increments of 1 nanometer therebetween. The average fiber diameter may be about 100 microns or less, such as about 75 microns or less, such as about 50 microns or less, such as about 45 microns or less, such as about 40 microns or less, such as about 35 microns or less, such as about 30 microns or less, such as about 25 microns or less, such as about 20 microns or less, such as about 15 microns or less, such as about 10 microns or less, such as about 5 microns or less, such as about 1 micron or less, such as about 900 nanometers or less, such as about 800 nanometers or less, such as about 600 nanometers or less, such as about 500 nanometers or less, such as about 300 nanometers or less, such as about 200 nanometers or less, such as about 100 nanometers or less, such as about 50 nanometers or less, such as about 25 nanometers or less, such as about 10 nanometers or less, such as about 5 nanometers or less. The fiber may have an average fiber diameter of about 1 nanometer or more, such as about 5 nanometers or more, such as about 10 nanometers or more, such as about 20 nanometers or more, such as about 30 nanometers or more, such as about 40 nanometers or more, such as about 50 nanometers or more, such as about 100 nanometers or more, such as about 250 nanometers or more, such as about 500 nanometers or more, such as about 750 nanometers or more, such as about 1 micron or more, such as about 5 microns or more, such as about 10 microns or more, such as about 15 microns or more, such as about 20 microns or more, such as about 25 microns or more, such as about 30 microns or more, such as about 35 microns or more, such as about 40 microns or more, such as about 45 microns or more, such as about 50 microns or more, such as about 75 microns or more. Furthermore, in one aspect, the aforementioned values may refer to a median fiber diameter.

The fiber (e.g., cellulose fiber) may have a selectively chosen average fiber length. In one aspect, an increase in the average fiber length of the fiber may increase the strength of the joint compound composition, such as compressive strength, tensile strength, and flexural strength. Notably, too much of an increase in average fiber length may result in decreased strength. In this respect, the decreased strength may be at least partially a result of weak bond strength between the fiber and the joint compound composition matrix. Further, for instance, the decreased strength may be at least partially a result of decreased fiber dispersion in the joint compound composition. The average fiber length of the fiber may be selectively chosen to increase the strength of the joint compound composition while also maintaining a suitable fiber dispersion in the joint compound composition.

In one aspect, the fiber (e.g., cellulose fiber) may have an average fiber length of about 5 nanometers to about 2000 microns, including all increments of 1 nanometer therebetween. In general, the fiber may have an average fiber length of less than about 1000 microns, such as about 500 microns or less, such as about 400 microns or less, such as about 300 microns or less, such as about 200 microns or less, such as about 150 microns or less, such as about 100 microns or less, such as about 75 microns or less, such as about 50 microns or less, such as about 45 microns or less, such as about 40 microns or less, such as about 35 microns or less, such as about 30 microns or less, such as about 25 microns or less, such as about 20 microns or less, such as about 15 microns or less, such as about 10 microns or less, such as about 5 microns or less, such as about 1 micron or less, such as about 900 nanometers or less, such as about 800 nanometers or less, such as about 600 nanometers or less, such as about 500 nanometers or less, such as about 300 nanometers or less, such as about 200 nanometers or less, such as about 100 nanometers or less, such as about 50 nanometers or less, such as about 25 nanometers or less, such as about 10 nanometers or less. Generally, the fiber may have an average fiber length of about 5 nanometers or more, such as about 10 nanometers or more, such as about 20 nanometers or more, such as about 30 nanometers or more, such as about 40 nanometers or more, such as about 50 nanometers or more, such as about 100 nanometers or more, such as about 250 nanometers or more, such as about 500 nanometers or more, such as about 750 nanometers or more, such as about 1 micron or more, such as about 5 microns or more, such as about 10 microns or more, such as about 15 microns or more, such as about 20 microns or more, such as about 25 microns or more, such as about 30 microns or more, such as about 35 microns or more, such as about 40 microns or more, such as about 45 microns or more, such as about 50 microns or more, such as about 75 microns or more, such as about 100 microns or more, such as about 200 microns or more, such as about 300 microns or more, such as about 400 microns or more, such as about 500 microns or more, such as about 1000 microns or more. Furthermore, in one aspect, the aforementioned values may refer to a median fiber length.

The fiber (e.g., cellulose fiber) may have a selectively chosen water absorption capacity. In one aspect, an increase in the water absorption capacity may reduce the occurrence of crack formation, reduce the severity of cracks when formed, provide for later joint compound composition hydration, and increase freeze-thaw durability of the joint compound composition. Notably, too high of a water absorption capacity may result in decreased strength of the joint compound composition and/or the rapid deterioration of the fiber in the joint compound composition. The water absorption capacity of the fiber may be selectively chosen to increase the durability of the joint compound composition while also maintaining enhanced strength.

In one aspect, the fiber (e.g., cellulose fiber) may have a water absorption capacity of about 0.01 g H₂O/g fiber to about 30 g H₂O/g fiber, including all increments of 0.01 g H₂O/g fiber therebetween. For instance, the fiber may have a water absorption capacity of about 0.01 g H₂O/g fiber or more, such as about 0.1 g H₂O/g fiber or more, such as about 1 g H₂O/g fiber or more, such as about 2 g H₂O/g fiber or more, such as about 5 g H₂O/g fiber or more, such as about 8 g H₂O/g fiber or more, such as about 10 g H₂O/g fiber or more, such as about 15 g H₂O/g fiber or more, such as about 20 g H₂O/g fiber or more, such as about 25 g H₂O/g fiber or more. Generally, the fiber may have a water absorption capacity of about 30 g H₂O/g fiber or less, such as about 25 g H₂O/g fiber or less, such as about 20 g H₂O/g fiber or less, such as about 15 g H₂O/g fiber or less, such as about 10 g H₂O/g fiber or less, such as about 8 g H₂O/g fiber or less, such as about 5 g H₂O/g fiber or less, such as about 2 g H₂O/g fiber or less, such as about 1 g H₂O/g fiber or less, such as about 0.1 g H₂O/g fiber or less. The aforementioned values may also be expressed in the form of percentages, including any respective percentage of any water absorption capacity disclosed herein. For instance, 1 g H₂O/g fiber equates to fiber having a water absorption capacity of 100% by weight. Further, for instance, 2 g H₂O/g fiber equates to fiber having a water absorption capacity of 200% by weight.

In general, one method of determining the water absorption capacity of the fiber involves preparing a sample of the fiber. Next, the fiber sample is weighed to determine its initial dry weight. Then, the fiber sample is submerged in water for a period of thirty minutes to one hour. Next, the fiber sample is removed from the water and allowed to drain. Then, the fiber sample is reweighed to determine the final weight of the fiber sample. The water absorption capacity may be determined by calculating the final weight minus the initial weight to obtain a value, then dividing that value by the initial weight to obtain a second value, and then multiplying the second value by 100. For instance, if the initial weight of the fiber sample is 1 gram and the final weight of the fiber sample is 3 grams, then the water absorption capacity would be 200% by weight or, in other words, 2 g H₂O/g.

Notably, the fiber (e.g., cellulose fiber) may have a selectively chosen pH. In one aspect, an increase in the pH of the fiber may increase the water absorption capacity of the fiber which may reduce the occurrence of crack formation, reduce the severity of cracks when formed, provide for later joint compound composition hydration, and increase the freeze-thaw durability of the joint compound composition. Notably, a pH that is too high may result in decreased strength of the joint compound composition and/or the rapid deterioration of the fiber in the joint compound composition. The pH of the fiber may be selectively chosen to increase the durability of the joint compound composition while also maintaining enhanced strength. The pH of the fiber may be determined by AOAC 943.02.

In one aspect, the fiber (e.g., cellulose fiber) may have a pH of about 3 to about 10, such as a pH of about 3 or more, such as a pH of about 4 or more, such as a pH of about 4.5 or more, such as a pH of about 5 or more, such as a pH of about 5.5 or more, such as a pH of about 6 or more, such as a pH of about 6.5 or more, such as a pH of about 7 or more, such as a pH of about 7.5 or more, such as a pH of about 8 or more. The fiber may have a pH of about 10 or less, such as about 9 or less, such as about 8 or less, such as about 7.5 or less, such as about 7 or less, such as about 6.5 or less, such as about 6 or less, such as about 5.5 or less, such as about 5 or less, such as about 4 or less.

In general, the fiber (e.g., cellulose fiber) may have a selectively chosen cellulose content. In one aspect, the fiber may be and/or include high purity cellulose fiber. As used herein, “high purity” cellulose fiber refers to cellulose fiber with a cellulose content above 90 wt. %. Notably, as the cellulose content of the cellulose fiber increases, the strength, such as the tensile strength, of a joint compound composition may also increase. The fiber (e.g., cellulose fiber) may have a cellulose content of about 20 wt. % to 100 wt. %, including all increments of 0.1 wt. % therebetween. For instance, the fiber may have a cellulose content of about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 85 wt. % or more, such as about 90 wt. % or more, such as about 95 wt. % or more, such as about 98 wt. % or more. The fiber may have a cellulose content of less than 100 wt. %, such as about 98 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less.

Generally, the fiber (e.g., cellulose fiber) may have a bulk density from about 0.01 g/cm³ to about 2 g/cm³, such as about 0.01 g/cm³ or more, such as about 0.05 g/cm³ or more, such as about 0.1 g/cm³ or more, such as about 0.15 g/cm³ or more, such as about 0.2 g/cm³ or more, such as about 0.3 g/cm³ or more, such as about 0.4 g/cm³ or more, such as about 0.5 g/cm³ or more, such as about 0.6 g/cm³ or more, such as about 0.7 g/cm³ or more, such as about 0.8 g/cm³ or more, such as about 0.9 g/cm³ or more. The fiber may have a bulk density of less than about 2 g/cm³, such as about 1 g/cm³ or less, such as about 0.9 g/cm³ or less, such as about 0.8 g/cm³ or less, such as about 0.7 g/cm³ or less, such as about 0.6 g/cm³ or less, such as about 0.5 g/cm³ or less, such as about 0.4 g/cm³ or less, such as about 0.3 g/cm³ or less, such as about 0.2 g/cm³ or less, such as about 0.1 g/cm³ or less. The bulk density may be determined by ISO 60:197 and/or DIN EN ISO 60.

Notably, the fiber (e.g., cellulose fiber) may have a selectively chosen particle size distribution. The particle size distribution of the fiber may be determined by ISO 4610:2001 and/or DIN EN ISO 4610. In one aspect, a mesh size of 300 microns may retain from about 0.01 wt. % to about 1 wt. % of the fiber (e.g., cellulose fiber), such as about 0.01 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more. Generally, a mesh size of 300 microns may retain about 1 wt. % or less of the fiber, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less.

In one aspect, a mesh size of 100 microns may retain from about 5 wt. % to about 40 wt. % of the fiber, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more. Generally, a mesh size of 100 microns may retain about 40 wt. % or less of the fiber, such as about 35 wt. % or less, such as about 30 wt. % or less, such as about 25 wt. % or less, such as about 20 wt. % or less, such as about 15 wt. % or less, such as about 10 wt. % or less.

In one aspect, a mesh size of 32 microns may retain from about 20 wt. % to about 90 wt. % of the fiber, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more. Generally, a mesh size of 32 microns may retain about 90 wt. % or less of the fiber, such as about 80 wt. % or less, such as about 70 wt. % or less, such as about 60 wt. % or less, such as about 50 wt. % or less, such as about 40 wt. % or less, such as about 30 wt. % or less.

In one aspect, the fiber (e.g., cellulose fiber) may have a D50 of about 1 micron or more, such as about 5 microns or more, such as about 10 microns or more, such as about 15 microns or more, such as about 25 microns or more, such as about 30 microns or more, such as about 35 microns or more, such as about 40 microns or more, such as about 45 microns or more, such as about 50 microns or more, such as about 75 microns or more. Generally, the fiber may have a D50 of about 100 microns or less, such as about 75 microns or less, such as about 50 microns or less, such as about 45 microns or less, such as about 40 microns or less, such as about 35 microns or less, such as about 30 microns or less, such as about 25 microns or less, such as about 20 microns or less, such as about 15 microns or less, such as about 10 microns or less, such as about 5 microns or less, such as about 4 microns or less, such as about 1 micron or less. The D50 of the fiber may be determined by a laser diffractometer such as a Microtrac S3500.

It should be understood that all of the aforementioned properties and characteristics of the fiber, including all quantitative expressions of such properties and characteristics, may be applicable to any and all of the fibers disclosed herein. For instance, any and all of the natural fibers may have an average fiber diameter, average fiber length, water absorption capacity, pH, cellulose content, bulk density, particle size distribution (e.g., fiber retainment by mesh size and D50 value), or a combination thereof in any of the respective corresponding values disclosed herein. For instance, any natural fiber of the present disclosure may have a cellulose content of about 60 wt. % or more.

The joint compound composition may include fiber (e.g., cellulose fiber) in an amount from about 0.01 wt. % to about 20 wt. %, including all increments of 0.01 wt. % therebetween. For instance, the joint compound composition may include fiber in an amount of about 0.01 wt. % or more, such as about 0.05 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 5 wt. % or more. The joint compound composition may include fiber in an amount of about 20 wt. % or less, such as about 15 wt. % or less, such as about 10 wt. % or less, such as about 5 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less. The aforementioned values may be based on the weight of the joint compound composition. Alternatively, the aforementioned values may be based on the weight of the cementitious filler in the joint compound composition.

As indicated herein, the joint compound composition may include water. In this regard, water may be present in an amount of at least 10 wt. %, such as at least 20 wt. %, such as at least 30 wt. %, such as at least 35 wt. %, such as at least 40 wt. %, such as at least 45 wt. %, such as at least 50 wt. % based on the weight of the joint compound composition. The water may be present in an amount of 90 wt. % or less, such as 80 wt. % or less, such as 70 wt. % or less, such as 60 wt. % or less, such as 55 wt. % or less, such as 50 wt. % or less, such as 45 wt. % or less, such as 40 wt. % or less based on the weight of the joint compound composition.

As also indicated herein, the joint compound composition may include a cementitious filler. The cementitious filler may include limestone, calcium carbonate, calcium magnesium carbonate, calcium sulfate dihydrate, or a mixture thereof. In one embodiment, the cementitious filler may include calcium carbonate. In another embodiment, the cementitious filler may include calcium magnesium carbonate. In a further embodiment, the cementitious filler may include calcium sulfate dihydrate. In another further embodiment, the cementitious filler may include a mixture of at least two of calcium carbonate, calcium magnesium carbonate, and calcium sulfate dihydrate, such as a mixture of calcium carbonate and calcium magnesium carbonate, a mixture of calcium carbonate and calcium sulfate dihydrate, or a mixture of calcium magnesium carbonate and calcium sulfate dihydrate. In a further embodiment, the cementitious filler may include a mixture of calcium carbonate, calcium magnesium carbonate, and calcium sulfate dihydrate.

Regardless, the cementitious filler may be present in an amount of at least 5 wt. %, such as at least 10 wt. %, such as at least 20 wt. %, such as at least 30 wt. %, such as at least 35 wt. %, such as at least 40 wt. %, such as at least 45 wt. %, such as at least 50 wt. % based on the weight of the joint compound composition. The cementitious filler may be present in an amount of 70 wt. % or less, such as 60 wt. % or less, such as 55 wt. % or less, such as 50 wt. % or less, such as 45 wt. % or less, such as 40 wt. % or less based on the weight of the joint compound composition. In addition, it should be understood that the aforementioned weight percentages may apply to a single cementitious filler used alone as well as a mixture of cementitious fillers.

In addition, the joint compound composition may include a mineral filler. The mineral filler may include a silicate. The silicate may be a nesosilicate, a sorosilicate, a cyclosilicate, an inosilicate, a phyllosilicate, a tectosilicate, or a mixture thereof. In one particular embodiment, the silicate may be a phyllosilicate. For instance, the mineral filler may include kaolin, montmorillonite, vermiculite, perlite, illite, halloysite, talc, pyrophyllite, palygorskite, attapulgite clay, sepiolite, mica, or a mixture thereof. In particular, the mineral filler may comprise mica, talc, pyrophyllite, or a mixture thereof. In one embodiment, the mineral filler may include mica. In another embodiment, the mineral filler may include talc. In another embodiment, the mineral filler may include pyrophyllite. In a further embodiment, the mineral filler may include a mixture of at least two of mica, talc, and pyrophyllite. For instance, the mineral filler may include a mixture of mica and talc. Alternatively, the mineral filler may include a mixture of talc and pyrophyllite. In another embodiment, the mineral filler may include a mixture of mica and pyrophyllite. In another further embodiment, the mineral filler may include a mixture of mica, talc, and pyrophyllite.

In one aspect, the joint compound composition may be substantially free of one or more mineral fillers. As used herein, “substantially free” refers to a mineral filler being present in the joint compound composition in an amount less than about 0.05% by weight. In one aspect, the joint compound composition may be free and/or substantially free of mica, pyrophyllite, and/or talc. In another aspect, the joint compound composition may be substantially free of mineral fillers. In this respect, the joint compound composition may contain less than 0.05% by weight of any mineral filler. In yet another aspect, the joint compound composition may contain no mineral fillers. In this respect, the joint compound composition may be free of mineral fillers.

Generally, mineral fillers such as mica and pyrophyllite have been traditionally used at least partially to enhance the crack resistance of a joint compound composition. Such mineral fillers generally have a high silica content. In this respect, the reduction of the content of mineral filler in the joint compound composition may reduce the silica content of the joint compound composition. In this respect, the reduction of the silica content of the joint compound composition may result in a joint compound composition that is more environmentally friendly and/or presents decreased health risks when compared to a traditional joint compound composition. However, it should be understood that any of the mineral fillers disclosed herein may be used in the joint compound composition of the present disclosure.

In one aspect, a mineral filler may be present in an amount of at least 0.01 wt. %, such as at least 0.05 wt. %, such as at least 0.1 wt. %, such as at least 0.5 wt. %, such as at least 1 wt. %, such as at least 2 wt. %, such as at least 5 wt. %, such as at least 8 wt. %, such as at least 10 wt. % based on the weight of the joint compound composition. Generally, a mineral filler may be present in an amount of 30 wt. % or less, such as 25 wt. % or less, such as 20 wt. % or less, such as 15 wt. % or less, such as 13 wt. % or less, such as 11 wt. % or less, such as 10 wt. % or less, such as 8 wt. % or less, such as 6 wt. % or less, such as 5 wt. % or less, such as 2 wt. % or less, such as 1 wt. % or less, such as 0.5 wt. % or less, such as 0.1 wt. % or less based on the weight of the joint compound composition. In addition, it should be understood that the aforementioned weight percentages may apply to a single mineral filler used alone as well as a mixture of mineral fillers.

In one aspect, the joint compound composition may include an elastomer. For instance, the elastomer may be an elastomeric polyester, an elastomeric polyurethane, an elastomeric polyamide, an elastomeric copolymer, and the like, and a mixture thereof. In one embodiment, the elastomer may be a copolymer. For instance, the copolymer may be a block copolymer, such as a substantially amorphous block copolymer having at least two blocks. The blocks may include a monoalkenyl arene polymer at and at least one block of a saturated conjugated diene polymer. In general, the monoalkenyl arene block may include a styrene. The styrene may include analogues and homologues, such as o-methyl styrene, p-methyl styrene, p-tert-butyl styrene, 2,3-dimethyl styrene, etc. The conjugated diene blocks may include a homopolymer of a conjugated diene monomer, a copolymer of two or more conjugated diene monomers, or a copolymer of one or more of the diene monomers with another monomer in which the blocks are predominantly conjugated diene units. The conjugated diene monomer may generally contain from 4 to 8 carbon atoms, such as 1,3-butadiene (butadiene), 2-methyl-1,3-butadiene, isoprene, 2,3-dimethyl-1,3-butadiene, 1,3-pentadiene (piperylene), 1,3-hexadiene, etc. The amount of monoalkenyl arene blocks may vary but may typically constitute 5 wt. % or more, such as 10 wt. % or more, such as 20 wt. % or more, such as 30 wt. % or more, such as 40 wt. % or more to 85 wt. % or less, such as 70 wt. % or less, such as 60 wt. % or less, such as 55 wt. % or less, such as 50 wt. % or less, such as 40 wt. % or less, such as 35 wt. % or less, such as 30 wt. % or less of the copolymer.

The elastomer may include a styrene-diene block copolymer, such as styrene-butadiene, styrene-isoprene, styrene-butadiene-styrene, styrene-isoprene-styrene, etc. The elastomer may also include a styrene-olefin block copolymer, such as styrene-(ethylene-butylene), styrene-(ethylene-propylene), styrene-(ethylene-butylene)-styrene, styrene-(ethylene-propylene)-styrene, styrene-(ethylene-butylene)-styrene-(ethylene-butylene), styrene-(ethylene-propylene)-styrene-(ethylene-propylene), and styrene-ethylene-(ethylene-propylene)-styrene. In one particular embodiment, the elastomer includes styrene-butadiene.

Regardless, the elastomer may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the joint compound composition. The elastomer may be present in an amount of 5 wt. % or less, such as 4 wt. % or less, such as 3 wt. % or less, such as 2 wt. % or less, such as 1.5 wt. % or less, such as 1.4 wt. % or less, such as 1.3 wt. % or less, such as 1.2 wt. % or less, such as 1.1 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition. In addition, it should be understood that the aforementioned weight percentages may apply to an elastomer used alone as well as a mixture of elastomers.

The elastomer may have a mean particle size of 0.01 μm or more, such as 0.05 μm or more, such as 0.1 μm or more, such as 0.12 μm or more, such as 0.14 μm or more, such as 0.15 μm or more, such as 0.2 μm or more. The elastomer may have a mean particle size of 1 μm or less, such as 0.8 μm or less, such as 0.6 μm or less, such as 0.5 μm or less, such as 0.4 μm or less, such as 0.3 μm or less, such as 0.25 μm or less, such as 0.2 μm or less, such as 0.18 μm or less, such as 0.16 μm or less, such as 0.15 μm or less. The mean particle size may be determined using various techniques as known in the art.

In one embodiment, the elastomer may be functionalized. For example, the terminals of the elastomer may be functionalized. The functional group may include an amine, a hydroxyl, an alkoxy, a sulfonate, a carboxyl, a phosphonate, a halogen, or a thiol. In one particular embodiment, functional group may include a carboxyl to provide a carboxylated elastomer. The carboxyl group may include, but is not limited to, an acrylic acid, a methacrylic acid, a maleic acid, an itaconic acid, etc.

The elastomer may have an elongation at break of 100% or more, such as 200% or more, such as 300% or more, such as 500% or more, such as 700% or more, such as 900% or more, such as 1,000% or more. The elastomer may have an elongation at break of 2,500% or less, such as 2,000% or less, such as 1,800% or less, such as 1,500% or less, such as 1,300% or less, such as 1,100% or less, such as 1,000% or less. The elongation at break may be determined according to ASTM D412-16.

In one embodiment, the elastomer may be presented as a dispersion, such as an aqueous dispersion. For example, the dispersion may include at least 10 wt. %, such as at least 20 wt. %, such as at least 30 wt. %, such as at least 40 wt. %, such as at least 45 wt. %, such as at least 50 wt. % solids based on the entire weight of the dispersion. The dispersion may include 80 wt. % or less, such as 70 wt. % or less, such as 60 wt. % or less, such as 55 wt. % or less, such as 50 wt. % or less solids based on the entire weight of the dispersion. The solids content may be determined in accordance with ISO 3251. One example of a commercially available elastomer is Lipaton® SB 5843 provided by Synthomer®.

As indicated herein, the joint compound composition may include a siloxane polymer. For instance, the siloxane polymer may be a dialkylsiloxane polymer. In this regard, the alkyl may be a C₁-C₄ alkyl, such as a C₁-C₂ alkyl, such as a C₁ alkyl (i.e., methyl). Accordingly, the siloxane polymer may be a dimethylsiloxane polymer (polydimethylsiloxane). Furthermore, the siloxane polymer may be modified. The modification may be a terminal modification or a side chain modification (e.g., to the alkyl, such as the methyl). In one embodiment, the modification is a terminal modification. In another embodiment, the modification is a side chain modification. Regardless, the modification may be by using a polyether to provide a polyether siloxane polymer (in other words a dimethicone copolyol). The polyether may be formed from polyethylene glycol, polypropylene glycol, or a mixture thereof. Such polyether may have 2 or more, such as 3 or more, such as 4 or more, such as 5 or more, such as 8 or more, such as 10 or more moles or repeat units. Such polyether may have 30 or less, such as 25 or less, such as 20 or less, such as 18 or less, such as 16 or less, such as 12 or less, such as 10 or less, such as 8 or less moles or repeat units. In one particular embodiment, the modification is a polyethylene glycol to provide a polyoxyethylene modified siloxane polymer, in particular a polyoxyethylene modified polydimethylsiloxane.

Regardless, the siloxane polymer may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.75 wt. % or more, such as 1 wt. % or more based on the weight of the joint compound composition. The siloxane polymer may be present in an amount of 5 wt. % or less, such as 4 wt. % or less, such as 3 wt. % or less, such as 2 wt. % or less, such as 1.5 wt. % or less, such as 1.25 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition.

In addition, the joint compound composition may also include a binder. The binder may include an acetate polymer, an acrylic polymer, a polyvinyl alcohol, a cellulose polymer, a starch, etc., or a mixture thereof. In one embodiment, the binder may include at least two of an acetate polymer, an acrylic polymer, a polyvinyl alcohol, a cellulose polymer, or a starch. For instance, in one embodiment, the binder may include at least a mixture of an acetate polymer and a cellulose polymer. In a further embodiment, the binder may include at least an acetate polymer. In another further embodiment, the binder may include at least a cellulose polymer.

The acetate polymer may include a vinyl acetate, such as an ethylene vinyl acetate. For instance, the acetate polymer may be a polyvinyl acetate, a polyethylene vinyl acetate, or a mixture thereof. In one embodiment, the acetate polymer may include polyvinyl acetate. In another embodiment, the acetate polymer may include polyethylene vinyl acetate. In an even further embodiment, the acetate polymer may be a mixture of two acetate polymers, such as any two of the aforementioned.

The acrylic polymer may be any acrylic polymer. For instance, the acrylic polymer may be a polyacrylate. In a further embodiment, the acrylic polymer may be a polyvinyl acrylic polymer. In another further embodiment, the acrylic polymer may be a polyvinyl acetate acrylate. In an even further embodiment, the acrylic polymer may be a mixture of two acrylic polymers, such as any two of the aforementioned.

The cellulose polymer may include a cellulose ether. For instance, the cellulose ether may include one wherein the hydroxyl groups are partially or fully replaced by —OR groups, wherein R is a substituted or substituted alkyl. For instance, the alkyl may be a C₁-C₆ alkyl. In particular, the alkyl may be methyl, ethyl, propyl, or a combination thereof. If a substitution is present, the substitution may include a hydroxy or a sulfo substitution. In addition, in one embodiment, the cellulose ether may be soluble in water at ambient temperature. The cellulose ether may be an alkyl cellulose, a hydroxyalkyl cellulose, or a mixture thereof. The cellulose ether may include, but is not limited to methylcellulose, ethyl cellulose, propyl cellulose, butyl cellulose, hydroxyethyl methylcellulose, hydroxypropyl methylcellulose, hydroxyethyl cellulose, ethylhydroxyethylcellulose, methylethylhydroxyethylcellulose, methylhydroxyethylcellulose, ethylmethylhydroxypropylcellulose, ethylhydroxyethylcellulose, etc., and mixtures thereof. In one particular embodiment, the cellulose ether may be a hydroxypropyl methylcellulose. The cellulose ether may have a particular degree of substitution (i.e., the average number of substituted hydroxyl groups per glucose united). The degree of substitution may be 0.1 or more, such as 0.2 or more, such as 0.3 or more, such as 0.5 or more, such as 1 or more, such as 1.3 or more, such as 1.5 or more, such as 2 or more. The degree of substitution may be 3 or less, such as 2.8 or less, such as 2.5 or less, such as 2.3 or less, such as 2 or less.

Regardless, the binder may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the joint compound composition. The binder may be present in an amount of 10 wt. % or less, such as 8 wt. % or less, such as 6 wt. % or less, such as 5 wt. % or less, such as 4 wt. % or less, such as 3 wt. % or less, such as 2 wt. % or less, such as 1.5 wt. % or less, such as 1.4 wt. % or less, such as 1.3 wt. % or less, such as 1.2 wt. % or less, such as 1.1 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less based on the weight of the joint compound composition. In addition, it should be understood that the aforementioned weight percentages may apply to a single binder used alone as well as a mixture of binders.

In one embodiment, the binder may be presented as an emulsion. For example, the emulsion may include at least 10 wt. %, such as at least 20 wt. %, such as at least 30 wt. %, such as at least 40 wt. %, such as at least 45 wt. %, such as at least 50 wt. % actives based on the entire weight of the emulsion. The emulsion may include 80 wt. % or less, such as 70 wt. % or less, such as 60 wt. % or less, such as 55 wt. % or less, such as 50 wt. % or less actives based on the entire weight of the emulsion.

In addition, in one embodiment, the joint compound composition may also include other additional fillers. For instance, these other additional fillers may include perlite, glass, etc. In one embodiment, the additional filler may include perlite. The perlite may be unexpanded perlite, expanded perlite, or a mixture thereof. In one embodiment, the perlite may include expanded perlite. In another embodiment, the additional filler may include a glass.

The additional filler, such as the perlite, may be treated. In one embodiment, it may remain untreated. In another embodiment, it may be treated such as to providing a coating. For instance, the treatment may be a hydrophobic treatment to provide a hydrophobic filler, such as a hydrophobic perlite. Such hydrophobicity may be obtained by treated the perlite with a surface-active agent. In this regard, the treatment and coating may be with one or more silanes, siloxanes, silicone coatings, or a mixture thereof. These may include in particular, but are not limited to, dimethyl silicone, dimethyldichlorosilane or polydimethylsiloxane. In addition or alternatively, coatings may also include titanates or zirconates. The coating may be provided in an amount of 0.01 wt. % or more, such as 0.02 wt. % or more, such as 0.05 wt. % or more, such as 0.1 wt. % or more, such as 0.2 wt. % or more, such as 0.5 wt. % or more to 5 wt. % or less, such as 4 wt. % or less, such as 3 wt. % or less, such as 2.5 wt. % or less, such as 2 wt. % or less, such as 1.5 wt. % or less, such as 1 wt. % or less based on the uncoated weight of the filler, such as the perlite.

Regardless, the additional filler may be present in an amount of at least 0.01 wt. %, such as at least 0.05 wt. %, such as at least 0.1 wt. %, such as at least 0.5 wt. %, such as at least 1 wt. %, such as at least 2 wt. %, such as at least 5 wt. %, such as at least 6 wt. %, such as at least 8 wt. %, such as at least 10 wt. % based on the weight of the joint compound composition. The additional filler may be present in an amount of 30 wt. % or less, such as 25 wt. % or less, such as 20 wt. % or less, such as 15 wt. % or less, such as 13 wt. % or less, such as 11 wt. % or less, such as 10 wt. % or less, such as 8 wt. % or less, such as 6 wt. % or less, such as 5 wt. % or less, such as 2 wt. % or less, such as 1 wt. % or less, such as 0.5 wt. % or less, such as 0.1 wt. % or less based on the weight of the joint compound composition. In addition, it should be understood that the aforementioned weight percentages may apply to a single additional filler used alone as well as a mixture of additional fillers.

In addition, the joint compound composition may also include a surfactant. In one particular embodiment, the joint compound composition may also include two surfactants. For instance, the surfactant may be cationic, anionic, nonionic, or amphoteric. In one embodiment, the surfactant may be anionic. In another embodiment, the surfactant may be nonionic. In a further embodiment, the surfactant may include one that is anionic and another that is nonionic. In this regard, the surfactant may include a surfactant system.

The anionic surfactant may include, but is not limited to, alkyl sulfates, sulfates of ethoxylate alcohols, aryl sulfonates, phosphates of ethoxylated alcohols, sulfosuccinates, sulfates and sulfonates of ethoxylated alkylphenols, and mixtures thereof. The nonionic surfactant may include, but is not limited to, ethoxylated alcohols, ethoxylated alkylphenols, and mixtures thereof. In one embodiment, the nonionic surfactant may be one that is known to be environmentally benign and (alkyl phenyl ethoxylate)-free, especially (nonylphenol ethoxylate)-free, examples of which include linear and/or branched alkyl ethoxylates. The cationic surfactant may include, but is not limited to, ethoxylated fatty amines and salts thereof. In one embodiment, the surfactant may include one having a polymerizable carbon-carbon double bond. These may include, but are not limited to, alkylphenol ethoxylates containing alkenyl substituents, polyoxyalkylene alkyl ether sulfate salts, salts of poly(oxy-1,2-ethanediyl), alpha-sulfo-omega-[1-(hydroxymethyl)-2-(2-propenyloxy) ethoxy], etc. Additional surfactants may include, but are not limited to, saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, sodium dodecylbenzenesulfonat.es and dihexyl esters of sodium sulfosuccinate, ethoxylated alkylphenols and ethoxylated alcohols, fatty alcohol (poly)ethersulfates and salts thereof.

The surfactant may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the joint compound composition. The surfactant may be present in an amount of 5 wt. % or less, such as 4 wt. % or less, such as 3 wt. % or less, such as 2 wt. % or less, such as 1.5 wt. % or less, such as 1.4 wt. % or less, such as 1.3 wt. % or less, such as 1.2 wt. % or less, such as 1.1 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition. In addition, it should be understood that the aforementioned weight percentages may apply to a single surfactant used alone as well as a mixture of surfactants.

In addition, the joint compound composition may also include a defoamer. The defoamer may include mineral oil, silicone oil, hydrocarbon oil, a polyglycol, a fatty acid derivative, a trialkyl phosphate, etc., or a mixture thereof. In one embodiment, the defoamer may include mineral oil (e.g., paraffin oil). In another embodiment, the defoamer may include silicone oil. In a further embodiment, the defoamer may include a mixture of mineral oil and silicone oil.

The defoamer may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the joint compound composition. The defoamer may be present in an amount of 5 wt. % or less, such as 4 wt. % or less, such as 3 wt. % or less, such as 2 wt. % or less, such as 1.5 wt. % or less, such as 1.4 wt. % or less, such as 1.3 wt. % or less, such as 1.2 wt. % or less, such as 1.1 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition. In addition, it should be understood that the aforementioned weight percentages may apply to a single defoamer used alone as well as a mixture of defoamers.

The joint compound composition may also include other additives as generally known in the art. These additives may include, but are not limited to, stabilizers, suspending agents, preservatives, pigments, colorants, flattening agents, UV absorbers, UV stabilizers, chemical markers/traceability agents, accelerators, etc.

For instance, in one embodiment, the joint compound composition may include at least one preservative. The preservative may include a biocide. For instance, such preservative may include a bactericide, a fungicide, a mildewcide, or a mixture thereof. Such preservatives may include any typically utilized in the art. For instance, they may include carbamates (e.g., IPBC), pyrithiones (e.g., sodium pyrithione, zinc pyrithione, etc.), isothiazolinones (e.g., BIT, BBIT), azoles (e.g., benzimidazoles, such as 2-(methoxycarbonylamino)benzimidazole), amines (e.g., alkanolamines, such as ethanolamines and in particular N-methylolethanolamine), etc. as well as mixtures thereof. In one particular embodiment, the biocide may include a mixture of an amine, an azole, and a carbamate. In another embodiment, the biocide may include a mixture of a pyrithione, an isothiazolinone, and a carbamate.

Regardless, the preservative may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.75 wt. % or more, such as 1 wt. % or more based on the weight of the joint compound composition. The preservative may be present in an amount of 5 wt. % or less, such as 4 wt. % or less, such as 3 wt. % or less, such as 2 wt. % or less, such as 1.5 wt. % or less, such as 1.25 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition. In addition, it should be understood that the aforementioned weight percentages may apply to a single preservative used alone as well as a mixture of preservatives.

In one aspect, the joint compound composition may include latex. Notably, latex may be present in the joint compound composition in an amount of about 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.4 wt. % or more, such as 1.5 wt. % or more, such as 1.6 wt. % or more based on the weight of the joint compound composition. Generally, the latex may be present in an amount of 5 wt. % or less, such as 4 wt. % or less, such as 3 wt. % or less, such as 2 wt. % or less, such as 1.5 wt. % or less, such as 1.4 wt. % or less, such as 1.3 wt. % or less, such as 1.2 wt. % or less, such as 1.1 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition.

In one aspect, the joint compound composition may include sorbitol. Notably, sorbitol may be present in the joint compound composition in an amount of about 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.4 wt. % or more, such as 1.5 wt. % or more, such as 1.6 wt. % or more based on the weight of the joint compound composition. Generally, the sorbitol may be present in an amount of 5 wt. % or less, such as 4 wt. % or less, such as 3 wt. % or less, such as 2 wt. % or less, such as 1.5 wt. % or less, such as 1.4 wt. % or less, such as 1.3 wt. % or less, such as 1.2 wt. % or less, such as 1.1 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition.

The joint compound composition may have a particular solids to water ratio. For instance, the solids may constitute 25 wt. % or more, such as 30 wt. % or more, such 35 wt. % or more, such as 40 wt. % or more, such as 45 wt. % or more, such as 50 wt. % or more of the joint compound composition. The solids may constitute 80 wt. % or less, such as 75 wt. % or less, such as 70 wt. % or less, such as 65 wt. % or less, such as 60 wt. % or less, such as 55 wt. % or less, such as 50 wt. % or less of the joint compound composition.

The joint compound composition may have better flow characteristics and takes less effort to apply. In this regard, the present joint compound composition may exhibit a relatively low viscosity. For instance, the joint compound composition may exhibit a viscosity of 50 poise or less, such as 40 poise or less, such as 30 poise or less, such as 25 poise or less, such as 20 poise or less, such as 15 poise or less, such as 10 poise or less when measured at a temperature of 23 °C and according to the method described below at a shear rate of 100 s⁻¹. The viscosity may be 1 poise or more, such as 2 poise or more, such as 3 poise or more, such as 4 poise or more, such as 5 poise or more, such as 6 poise or more, such as 7 poise or more, such as 8 poise or more, such as 9 poise or more, such as 10 poise or more when measured at a temperature of 23 °C and according to the method described below at a shear rate of 100 s⁻¹.

In some aspects, the joint compound composition disclosed herein may have a viscosity of about 100 BU to about 1000 BU, where “BU” refers to Brabender units. For instance, the joint compound composition disclosed herein may have a viscosity of about 100 BU or more, such as about 200 BU or more, such as about 300 BU or more, such as about 400 BU or more, such as about 500 BU or more, such as about 600 BU or more, such as about 700 BU or more, such as about 800 BU or more, such as about 900 BU or more. The joint compound composition disclosed herein may have a viscosity of about 1000 BU or less, such as about 900 BU or less, such as about 800 BU or less, such as about 700 BU or less, such as about 600 BU or less, such as about 500 BU or less, such as about 400 BU or less, such as about 300 BU or less, such as about 200 BU or less.

In addition, the joint compound composition as disclosed herein may demonstrate a lower yield stress. For instance, the yield stress may be 1,500 dynes/cm² or less, such as 1,300 dynes/cm² or less, such as 1,100 dynes/cm² or less, such as 1,000 dynes/cm² or less, such as 800 dynes/cm² or less, such as 600 dynes/cm² or less, such as 500 dynes/cm² or less, such as 400 dynes/cm² or less when measured at a temperature of 23 °C and according to the method described below. The yield stress may be 100 dynes/cm² or more, such as 200 dynes/cm² or more, such as 300 dynes/cm² or more, such as 400 dynes/cm² or more, such as 500 dynes/cm² or more when measured at a temperature of 23 °C and according to the method described below. Without intending to be limited by theory, the lower yield stress generally indicates a lower effort to apply. In addition, the present inventors have discovered that, unlike more traditional joint compound compositions, the joint compound composition as disclosed herein has a longer “life.” For instance, the joint compound composition as disclosed herein may be able to sit for a longer period of time without thickening to a degree that would require remixing.

Furthermore, the present invention is also directed to a method of making the aforementioned joint compound composition. In particular, the method may include a step of combining and mixing any of the aforementioned components. In particular, in one embodiment, the method may include a step of providing or combining and mixing water, a cementitious filler, and fiber, such as natural fiber. Additionally, the method may include a step of applying the joint compound composition to a joint between adjacent gypsum wallboards. After allowing the joint compound composition to dry and cure, tape, such as drywall joint tape, may be applied to a portion of the joint compound composition or may be applied over the entirety of the joint compound composition.

These components provided with respect to the method are as defined above with respect to the joint compound composition. In addition, it should be understood that, in the method, the other components mentioned above with respect to the joint compound composition may also be provided, combined, and/or mixed in the method. Furthermore, the resulting joint compound composition may have the individual components within the weight percentages as mentioned above with respect to the joint compound composition. In addition, the resulting joint compound composition may also have the properties as mentioned above with respect to the joint compound composition.

The joint compound composition as mentioned herein may have application in the building industry. For instance, the joint compound composition may be available as a “ready-mix” formulation (ready to use without needing additional water). The joint compound composition can be utilized with construction panels such as gypsum wallboards. In particular, the joint compound compositions can be applied to gaps (or joints) between adjacent, affixed gypsum wallboards, whether applied to a gap itself or joint tape applied over the gap. In addition, the joint compound composition can be applied to any cracks or screw holes and/or nail holes used to affix the gypsum wallboards. Such application of the joint compound composition can provide a smooth, visually appealing surface.

In addition, with the use of the components as defined herein, the joint compound composition is generally regarded as a drying-type joint compound composition. For instance, after application, the water evaporates and the composition dries to form a relatively hard cementitious material. Once hardened, the remaining material may be sanded to provide a smoother surface that may be later manipulated (e.g., painted).

### EXAMPLES

### Example 1

A joint compound composition was prepared according to the formulation provided below in Table 1.

TABLE 1

| | Amount |
|---|---|
| Component | [Wt. %] |
| Limestone | 64.576% |
| Water | 30.351% |
| Attapulgite Clay | 1.710% |
| Latex | 1.422% |
| Cellulose Fiber | 0.796% |
| Perlite | 0.352% |
| Hydroxyethyl Methylcellulose | 0.267% |
| Sorbitol | 0.163% |
| Hydroxyethyl Cellulose | 0.147% |
| Biocide | 0.103% |
| Polyvinyl Alcohol | 0.082% |
| Defoamer | 0.017% |
| Fungicide | 0.016% |

### Example 2

Joint compound compositions were prepared and analyzed for various viscosity measurements. The viscosity of all of the samples was measured with a viscometer utilizing an RPM of 75 and a ⅛ inch spindle. The respective values of Table 2 are presented in the format of two measurements on the left column and the average value of the two measurements in the right column. Control 1 and Control 2 contained no cellulose fiber. Trial 1 contained 0.5 wt. % cellulose fiber by weight of the joint compound composition. Trial 2 contained 1.0 wt. % cellulose fiber by weight of the joint compound composition.

TABLE 2

| | Control 1 | | Trial 1 | | Control 2 | | Trial 2 | |
|---|---|---|---|---|---|---|---|---|
| Total Water [lbs] | 3840 | 3787 | 3761 | 3777.5 | 3848 | 3845.5 | 3966 | 3935.5 |
| | 3734 | | 3794 | | 3843 | | 3905 | |
| Release Viscosity [BU] | 572 | 567 | 568 | 564.5 | 570 | 563 | 582 | 568.5 |
| | 562 | | 561 | | 556 | | 555 | |
| Fill Viscosity [BU] | 560 | 561 | 552 | 552.5 | 571 | 561 | 557 | 558 |
| | 562 | | 553 | | 551 | | 559 | |
| 24 Hour Viscosity [BU] | 618 | 621 | 594 | 599 | 560 | 562.5 | 598 | 598.5 |
| | 624 | | 604 | | 565 | | 599 | |
| 7 Day Viscosity [BU] | 600 | 584.5 | 600 | 607.5 | 527 | 547 | — | — |
| | 569 | | 615 | | 567 | | — | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A joint compound composition comprising:
water;
a cementitious filler; and
natural fiber, wherein the natural fiber is present in the joint compound composition in an amount from about 0.05 wt. % to about 20 wt. %;
wherein the joint compound composition has a viscosity from about 100 BU to about 1000 BU.

2. (canceled)

3. The joint compound composition of claim 1, wherein the natural fiber comprises cellulose fiber, the natural fiber being is present in the joint compound composition in an amount from about 0.1 wt. % to about 10 wt. %.

4. The joint compound composition of claim 1, wherein the water is present in the joint compound composition in an amount from about 10 wt. % to about 50 wt. %.

5. (canceled)

6. The joint compound composition of claim 1, wherein the cementitious filler comprises calcium carbonate.

7. The joint compound composition of claim 1, wherein the cementitious filler is present in the joint compound composition in an amount from about 40 wt. % to about 80 wt. %.

8. (canceled)

9. The joint compound composition of claim 1, wherein the joint compound composition further comprises a mineral filler, the mineral filler comprising attapulgite clay.

10. (canceled)

11. The joint compound composition of claim 9, wherein the mineral filler is present in the joint compound composition in an amount from about 0.1 wt. % to about 10 wt. %

12. The joint compound composition of claim 1, wherein the joint compound composition is substantially free of mica, pyrophyllite, and talc.

13. (canceled)

14. The joint compound composition of claim 1, wherein the joint compound composition further comprises at least one surfactant, the surfactant comprising an anionic surfactant, a nonionic surfactant, or a combination thereof.

15. (canceled)

16. The joint compound composition of claim 1, wherein the joint compound composition further comprises a defoamer, the defoamer comprising a mineral oil, a silicone oil, or a mixture thereof.

17. (canceled)

18. The joint compound composition of claim 16, wherein the defoamer is present in the joint compound composition in an amount from about 0.001 wt. % to about 5 wt. %.

19. The joint compound composition of claim 1, wherein the joint compound composition further comprises a binder, the binder comprising an acetate polymer, a cellulose polymer, a polyvinyl alcohol, or a combination thereof.

20. (canceled)

21. The joint compound composition of claim 19, wherein the binder is present in the joint compound composition an amount from about 0.01 wt. % to about 10 wt. %.

22. The joint compound composition of claim 1, wherein the joint compound composition further comprises perlite.

23. The joint compound composition of claim 1, wherein the joint compound composition further comprises a cellulose ether, the cellulose ether comprising hydroxyethyl cellulose, hydroxyethyl methylcellulose, or a combination thereof.

24. (canceled)

25. The joint compound composition of claim 23, wherein the cellulose ether is present in the joint compound composition in an amount from about 0.05 wt. % to 10 wt. %.

26. (canceled)

27. The joint compound composition of claim 1, wherein the natural fiber has an average fiber diameter of about 1 micron to about 100 microns and an average fiber length of about 1 micron to about 1000 microns.

28. (canceled)

29. The joint compound composition of claim 1, wherein the natural fiber has a water absorption capacity of about 0.1 g H₂O/g fiber to about 30 g H₂O/g fiber.

30. The joint compound composition of claim 1, wherein the natural fiber has a pH of 4 to 8.

31. The joint compound composition of claim 1, wherein the natural fiber has a 20% maximum of retained fibers for a mesh size of 100 microns.

32. The joint compound composition of claim 1, wherein the natural fiber has a D50 of about 1 micron to about 100 microns.

33. The joint compound composition of claim 1, wherein the natural fiber has a bulk density from about 0.01 g/cm³ to about 1 g/cm³.

34. (canceled)

35. The joint compound composition of claim 2, wherein the cellulose fiber is a high purity cellulose fiber.

36. A method of forming and applying the joint compound composition of claim 1, the method comprising:
combining and mixing the water, the cementitious filler, and the natural fiber, wherein the natural fiber is present in the joint compound composition in an amount from about 0.05 wt. % to about 20 wt, wherein the joint compound composition has a viscosity from about 100 BU to about 1000 BU;
applying the joint compound composition to a joint between adjacent gypsum wallboards;
allowing the joint compound composition to dry and cure; and
applying a tape to a portion of the joint compound composition or to the entirety of the joint compound composition.
